(19) United States
(12) Patent Application Publication
(10) Pub. No.: US 2026/0117917 A1
(43) Pub. Date: Apr. 30, 2026

(54) INSTALLATION AND POSITIONING DEVICE FOR TELEVISION MOUNT

(71) Applicant: Legrand AV Inc., Minnetonka, MN (US)

(72) Inventor: Adam Maves, Minnetonka, MN (US)

(21) Appl. No.: 19/163,144

(22) PCT Filed: Mar. 8, 2024
(86) PCT No.: PCT/US2024/019273

§ 371 Date: Sep. 8, 2025

Related U.S. Application Data
(60) Provisional application No. 63/450,853, filed on Mar. 8, 2023.

(51) Int. Cl. F16M 11/12; F16M 11/20; F16M 13/02

(52) U.S. Cl. CPC F16M 11/126; F16M 11/2014; F16M 11/2092; F16M 13/02; F16M 2200/022; F16M 2200/068

(57) ABSTRACT

A full-motion television or display monitor mount having a wall interface and a display interface. The display interface is operably coupled to the wall interface so that the display interface can be shifted in pitch and yaw. Handle assemblies are coupled to the display interface and are selectively shiftable amongst an extended position enabling lifting and attachment of the display interface and television or display monitor to the wall interface, an intermediate positioning position enabling shifting of the television or display monitor in pitch and yaw, and a stowed position for concealing the handle assemblies behind the television or display monitor. Methods for positioning a television or display monitor are also described.

### RELATED APPLICATIONS

The present application claims priority to PCT Application No. PCT/US2024/019273, entitled INSTALLATION AND POSITIONING DEVICE FOR TELEVISION MOUNT, filed Mar. 8, 2024, and claims the benefit of U.S. Provisional Application No. 63/450,853, entitled INSTALLATION AND POSITIONING DEVICE FOR TELEVISION MOUNT, filed Mar. 8, 2023, said application being hereby fully incorporated herein in its entirety by reference in their entirety.

### TECHNICAL FIELD

The invention is related to television and display monitor mounts, and more specifically devices for installing and positioning mounted televisions and display monitors.

### BACKGROUND

Flat screen televisions and monitors, such as those using LCD, LED, or OLED technology, have become very common. Such devices can provide a large, lightweight, high performance display screen that is also very thin. As technology has improved and prices have decreased, devices with very large display screens, for example 55 diagonal inches and up, have become popular.

It is often desirable for televisions to be mounted to be freely maneuverable to adjust the orientation of the screen to fit user preferences. For this reason, mounts often have extendable arms and tilt and swivel capability-referred to in the industry as “full-motion” mounts. Especially with larger screens, it is important that the screen be securely mounted and stably supported to prevent wobbling and sagging, and for safety reasons.

With the trend toward televisions and display monitors that have a large viewing area and also that are increasingly thin, these devices have also become somewhat delicate and sensitive to damage during mounting and positioning. Even hand pressure on the screen or slight bending can cause the viewing screen to be permanently damaged.

What is needed are mounts, systems, and methods that enable installation and positioning of a television or display monitor without damaging the screen.

### SUMMARY

According to embodiments of the inventions disclosed herein, mounts, systems and methods are provided that enable installation and positioning of a television and address the problem of damage to the screen. Embodiments of the invention can include a full-motion television or display monitor mount having a wall interface and a display interface. The display interface is operably coupled to the wall interface so that the display interface can be shifted in pitch and yaw. Handle assemblies are coupled to the display interface and are selectively shiftable amongst an extended position enabling lifting and attachment of the display interface and television or display monitor to the wall interface, an intermediate positioning position enabling shifting of the television or display monitor in pitch and yaw, and a stowed position for concealing the handle assemblies behind the television or display monitor.

In an embodiment, a mount for attaching a television to a structure includes a wall interface adapted to attach to the structure, a display interface adapted to attach to the television, the display interface operably coupled to the wall interface such that the display interface is selectively shiftable in pitch and yaw relative to the wall interface, and a pair of handle assemblies. The handle assemblies are operably coupled to the display interface, each handle assembly having an elongate shaft with a pair of opposing ends, one of the opposing ends coupled to the display interface and the other one of the opposing ends having a grip portion, each handle assembly being selectively shiftable amongst a first extended position wherein the shaft extends in a generally horizontal direction and the grip portion is disposed laterally outward from the display interface, a second intermediate position wherein the shaft portion extends in a generally vertical direction and the grip portion is disposed above or below the display interface, and a third stowed position wherein the shaft extends in a generally horizontal direction and the grip portion is disposed above or below the display interface.

The display interface can include a pair of vertically spaced-apart support bars, each support bar presenting a pair of opposing ends, one of the handle assemblies being pivotally coupled to a first one of the support bars proximate one of the opposing ends of the support bar, the other one of the handle assemblies being pivotally coupled to the first one of the support bars proximate the other of the opposing ends of the support bar. Each handle assembly can further include a guide plate defining a guide slot, wherein the support bar carries a corresponding guide pin engaged and slidable in the guide slot.

In an embodiment the mount further comprises an arm assembly operably coupling the wall interface and the display interface.

In an embodiment, the mount includes a tilt guide bracket defining a pair of vertically spaced-apart guide slots and operably coupled to the display interface, and the mount further includes a pair of guide pins operably coupled to the wall interface, each one of the pair of guide pins engaged in a separate one of the guide slots, thereby enabling the display interface to tilt about a generally horizontal tilt axis disposed forwardly from the display interface. The guide slots can be arcuate and disposed along the circumference of a circle, the circle having a center disposed forwardly from the display interface.

In an embodiment, the mount includes a tilt guide bracket defining a pair of vertically spaced-apart guide slots and operably coupled to the display interface, and the mount further includes a pair of guide pins operably coupled to the wall interface, each one of the pair of guide pins engaged in a separate one of the guide slots, thereby enabling the display interface to tilt about a generally horizontal instantaneous tilt axis disposed forwardly from the display interface. The guide slots can be straight and/or disposed asymmetrically relative to each other.

In other embodiments, a video display system includes a television or display monitor, and a mount for movably attaching the television or display monitor to a wall. The mount includes a wall interface adapted to attach to the wall, a display interface attached to the television or display monitor, the display interface operably coupled to the wall interface such that the display interface is selectively shiftable in pitch and yaw relative to the wall interface, and a pair of handle assemblies operably coupled to the display interface, each handle assembly having an elongate shaft with a pair of opposing ends, one of the opposing ends coupled to the display interface and the other one of the opposing ends having a grip portion, each handle assembly being selectively shiftable amongst a first extended position wherein the shaft extends in a generally horizontal direction and the grip portion is disposed laterally outward from the display interface, a second intermediate position wherein the shaft portion extends in a generally vertical direction and the grip portion is disposed above or below the display interface, and a third stowed position wherein the shaft extends in a generally horizontal direction and the grip portion is disposed above or below the display interface.

In embodiments, the display interface of the system includes a pair of vertically spaced-apart support bars, each support bar presenting a pair of opposing ends, one of the handle assemblies being pivotally coupled to a first one of the support bars proximate one of the opposing ends of the support bar, the other one of the handle assemblies being pivotally coupled to the first one of the support bars proximate the other of the opposing ends of the support bar. Each handle assembly can further include a guide plate defining a guide slot, wherein the support bar carries a corresponding guide pin engaged and slidable in the guide slot.

In embodiments of the system, the mount further includes an arm assembly operably coupling the wall interface and the display interface.

In embodiments, the mount of the system includes a tilt guide bracket defining a pair of vertically spaced-apart guide slots and operably coupled to the display interface, and the mount further includes a pair of guide pins operably coupled to the wall interface, each one of the pair of guide pins engaged in a separate one of the guide slots, thereby enabling the display interface to tilt about a generally horizontal tilt axis disposed forwardly from the display interface. The guide slots can be arcuate and disposed along the circumference of a circle, the circle having a center disposed forwardly from the display interface.

In other embodiments of the system, the mount includes a tilt guide bracket defining a pair of vertically spaced-apart guide slots and operably coupled to the display interface, and the mount further includes a pair of guide pins operably coupled to the wall interface, each one of the pair of guide pins engaged in a separate one of the guide slots, thereby enabling the display interface to tilt about a generally horizontal instantaneous tilt axis disposed forwardly from the display interface. The guide slots can be straight and/or disposed asymmetrically relative to each other.

In other embodiments, a method of positioning a television or display monitor relative to a structure includes first providing a mount, the mount including a wall interface adapted to attach to the structure, a display interface adapted to attach to the television or display monitor, the display interface operably couplable to the wall interface such that the display interface is selectively shiftable in pitch and yaw relative to the wall interface, and a pair of handle assemblies operably coupled to the display interface. Each handle assembly has an elongate shaft with a pair of opposing ends, one of the opposing ends coupled to the display interface and the other one of the opposing ends having a grip portion, each handle assembly being selectively shiftable amongst a first extended position wherein the shaft extends in a generally horizontal direction and the grip portion is disposed laterally outward from the display interface, a second intermediate position wherein the shaft portion extends in a generally vertical direction and the grip portion is disposed above or below the display interface, and a third stowed position wherein the shaft extends in a generally horizontal direction and the grip portion is disposed above or below the display interface. The method further includes attaching the wall interface to the structure, attaching the display interface to the television or display monitor, shifting each of the handle assemblies to the first extended position, coupling the display interface to the wall interface, shifting each of the handle assemblies to the second intermediate position, and shifting the television or display monitor to a desired pitch position or a desired yaw position using the handle assemblies. Finally, the handle assemblies can be shifted to the stowed position.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

The subject matter hereof may be more completely understood in consideration of the following detailed description of various embodiments in connection with the accompanying figures, in which:

FIG. 1 is a rear isometric view of a television and mount with installation and positioning handles according to embodiments of the invention;

FIG. 2 is a rear elevation view of the TV bracket of the mount of FIG. 1 attached to a television;

FIG. 3 is a close-up partial isometric view of one of the handle assemblies of the mount of FIG. 1;

FIG. 4 is rear isometric view of the mount and television of FIG. 1 with the handle assemblies positioned in a stowed position;

FIG. 5 is a rear isometric view of the mount and television of FIG. 1 with the handle assemblies positioned in an installation position;

FIG. 6 is a rear isometric view of the mount and television of FIG. 1 with the handle assemblies positioned in a positioning position;

FIG. 7 is a front isometric view of the mount and television of FIG. 1 with the television depicted in phantom and the handle assemblies being used to extend and retract the mount arms to position the television toward or away from the wall;

FIG. 8 is a front isometric view of the mount and television of FIG. 1 with the television depicted in phantom and the handle assemblies being used to horizontally swivel the television;

FIG. 9 a front isometric view of the mount and television of FIG. 1 with the television depicted in phantom and the handle assemblies being used to vertically tilt the television;

FIG. 10 is a front isometric view of a display mount with adjustable wall attachment according to an embodiment of the invention;

FIG. 11 is a front isometric view of the display mount of FIG. 10, with an electronic display device attached, and the mount attached to a wall;

FIG. 12 is a rear isometric view of the wall interface assembly of the mount of FIG. 10;

FIG. 13 is a partial front isometric view of a lower wall interface coupling of the wall interface assembly of FIG. 12;

FIG. 14 is a partial front isometric view of an upper wall interface coupling of the wall interface assembly of FIG. 12;

FIG. 15 is a partial exploded view of the upper portion of the pivot assembly of the wall interface assembly of FIG. 12;

FIG. 16 is an isometric view of the pivot assembly of the wall interface assembly of FIG. 12;

FIG. 17 is a top plan view of the pivot assembly of the wall interface assembly of FIG. 12, with the upper bushing block depicted in phantom for clarity;

FIG. 18 is a partial front isometric view of the lower bushing block of the wall interface assembly of FIG. 12;

FIG. 19 is a rear isometric view of the display interface assembly of the display mount of FIG. 10;

FIG. 20 is a right elevation view of the display interface assembly, depicting the display tilt feature of the mount;

FIG. 21 is a partial rear isometric view of the tilt mechanism of the display interface assembly of FIG. 19;

FIG. 22 is a partial rear isometric view of the display height adjustment mechanism of the display interface assembly of FIG. 19;

FIG. 23 is a partial isometric view of the pivoting connection between the upper and lower arms of the mount of FIG. 10, with the arm covers depicted in phantom; and

FIG. 24 is a schematic diagram showing a wall interface, display interface, and display wherein asymmetrically positioned guide slots create an instantaneous tilt axis about which the display and display interface rotate.

While various embodiments are amenable to various modifications and alternative forms specifics thereof have been shown by way of example in the drawings and will be described in detail. It should be understood, however, that the intention is not to limit the claimed inventions to the embodiments described. On the contrary, the intention is to cover all modifications, equivalents, and alternatives falling within the spirit and scope of the subject matter as defined by the claims.

### DETAILED DESCRIPTION OF THE DRAWINGS

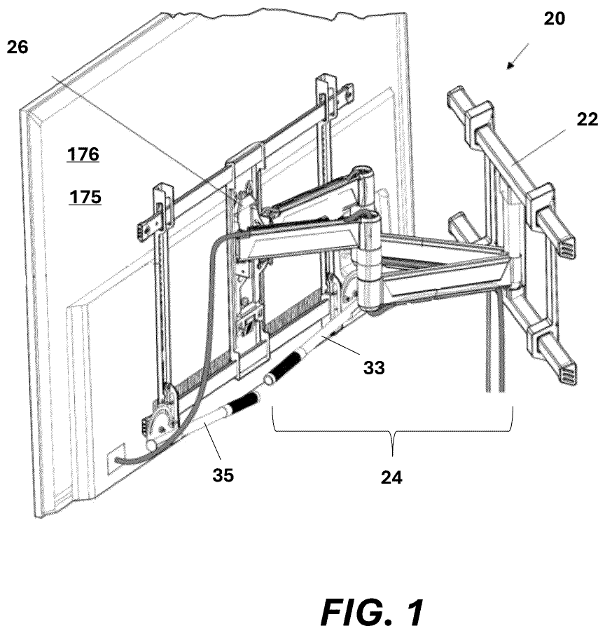

As depicted in FIG. 1, full-motion display mount 20 according to embodiments of the invention generally includes wall interface assembly 22, arm assembly 24, display interface assembly 26, and handle assemblies 33, 35. The structure, installation, and operation of wall interface assembly 22, arm assembly 24, and display interface assembly 26 is further described below.

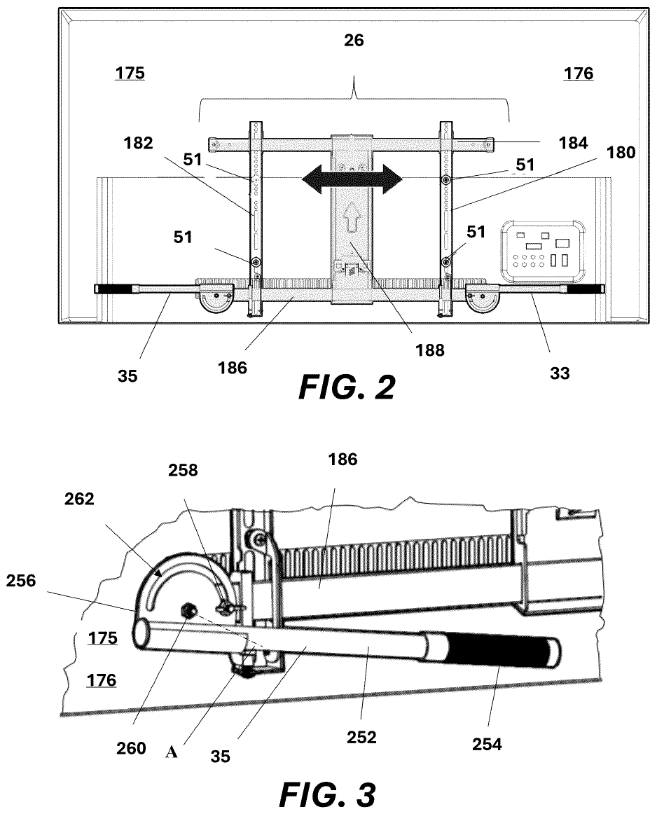

As depicted in FIG. 2, display interface assembly 26 generally includes tilt interface channel 188, support bars 184, 186, and display mounting brackets 180, 182. display mounting brackets 180, 182, are secured to rear side 175 of television 176 with fasteners 51.

As depicted in FIG. 3, each of handle assemblies 33, 35, generally includes handle shaft 252, grip 254, guide plate 256, guide pin 258, and pivot 260. Handle shaft 252 is fixed to guide plate 256. Guide plate 256 defines arcuate guide slot 262, and guide pin 258 is carried by support bar 186. Guide plate 256 is pivotally attached to support bar 186, enabling handle shaft 252 to be pivoted around axis A, with guide slot 262 sliding over guide pin 258.

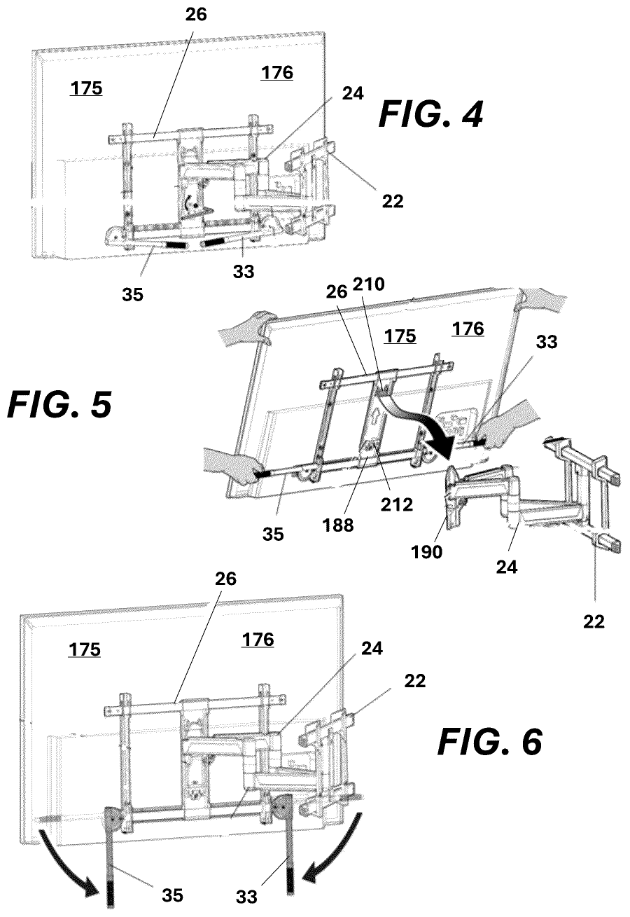

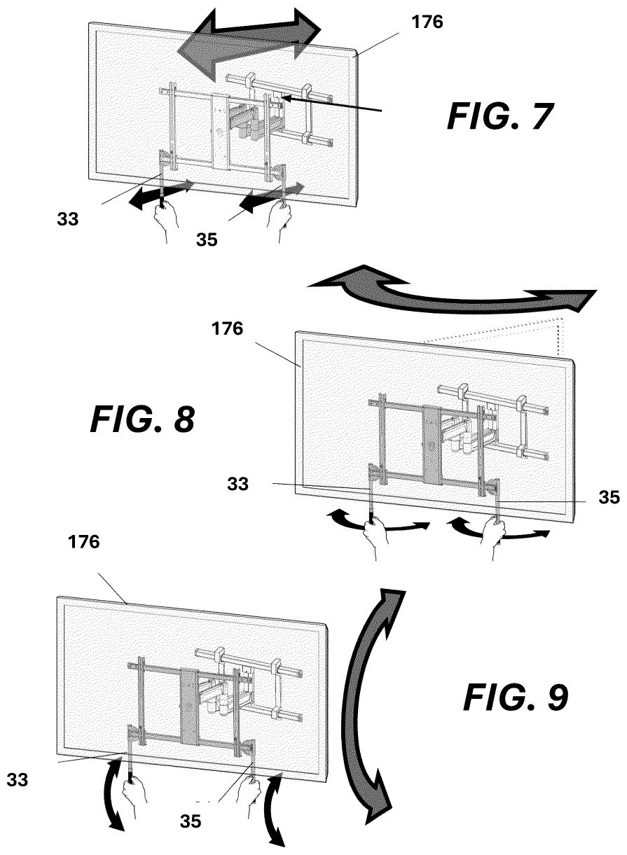

Handle assemblies 33, 35, can be separately positioned in any position within the range of travel permitted by guide slot 262 and guide pin 258, including a stowed position depicted in FIG. 4, wherein handle shaft 252 extends in a generally horizontal direction and grip 254 is disposed below display interface 26, an installation position depicted in FIG. 5, wherein handle shaft 252 extends in a generally horizontal direction and grip 254 is disposed laterally outward relative to display interface 26, and a TV positioning position depicted in FIG. 6, wherein handle shaft 252 extends in a generally vertical direction and grip 254 is disposed below display interface 26. Accordingly, a user may attach wall interface assembly 22 to a wall 90, and display interface assembly 26 may be separately attached to rear side 175 of television 176. Handle assemblies 33, 35, may then be pivoted to the extended installation position depicted in FIG. 5. Users can then use grips 254 to lift television 176 and engage clips 210, 212, on tilt interface channel 188 with tilt guide bracket 190, which is already attached to arm assembly 24 to mount television 176 as depicted in FIG. 5. With television 176 mounted and secured, handle assemblies 33, 35, can be pivoted to the TV positioning position as depicted in FIG. 6. In this position, a user may then position television 176 toward or away from the wall, swivel television 176 horizontally (yaw), or tilt television 176 vertically (pitch) by pulling or pushing grips 254, as depicted in FIGS. 7, 8, and 9, respectively. Once television 176 is positioned as desired, handle assemblies 33, 35, can be folded into the stowed position depicted in FIG. 4, thereby concealing them from view from the screen side of television 176. It will be appreciated that handle assemblies 33, 35, could be coupled to upper support bar 184, instead of lower support bar 186 as depicted, in which case grips 254 will be disposed above rather than below display interface 26 in the installation and stowed positions.

Hence, television 176 can be mounted and positioned with minimal need for a user to grasp the television 176 itself, thereby avoiding possible damage. Also, handle assemblies 33, 35, enable safer and more manageable installation by providing gripping points, thereby minimizing the potential of dropping the television causing damage or injury.

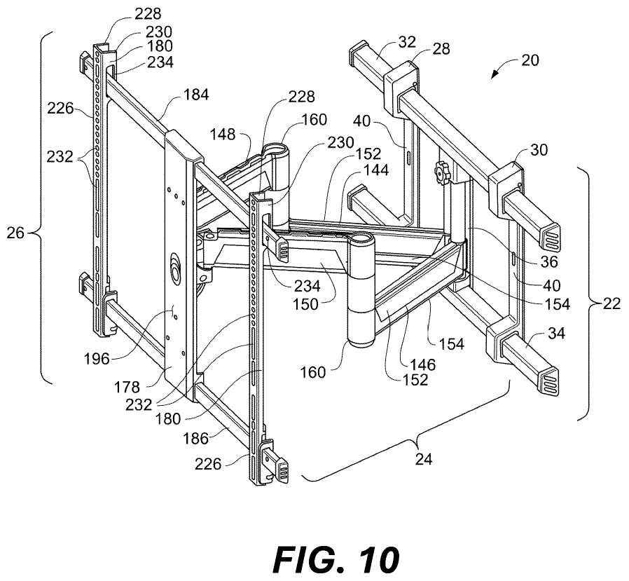

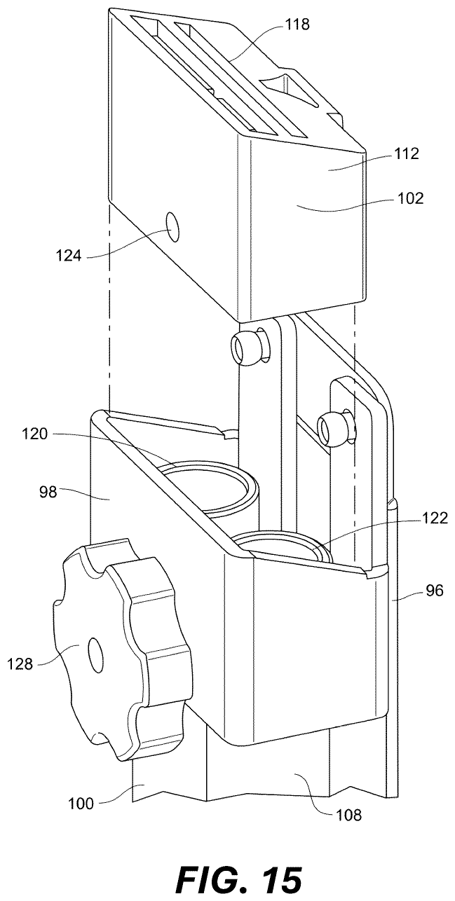

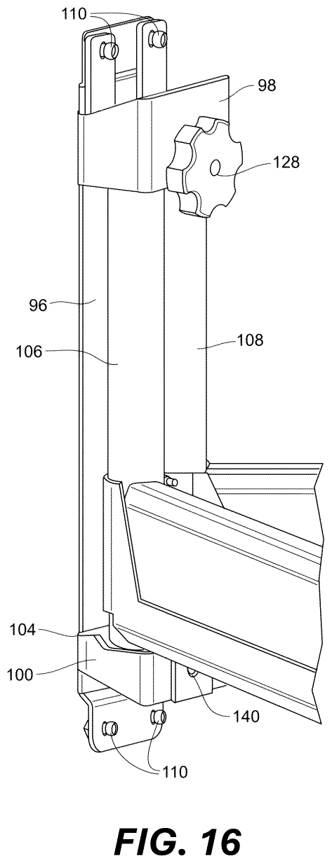

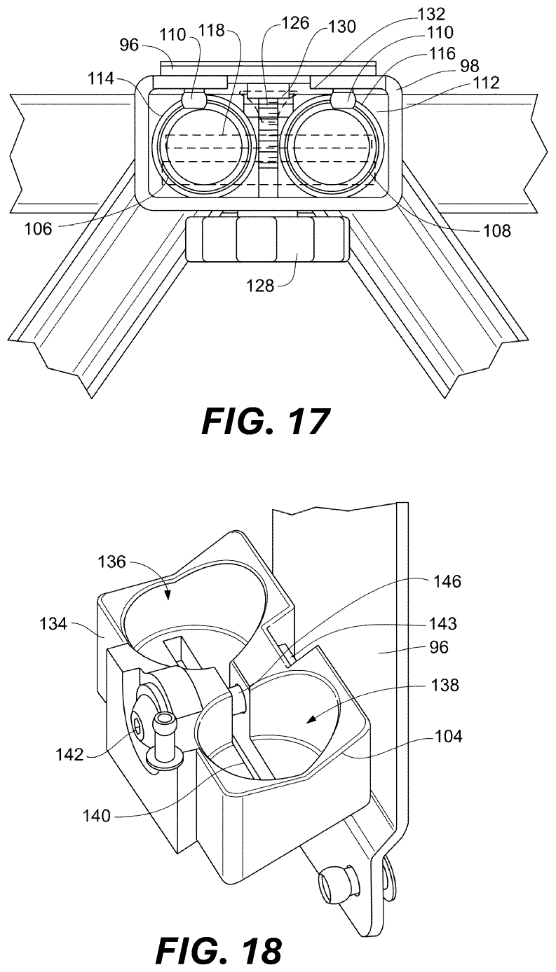

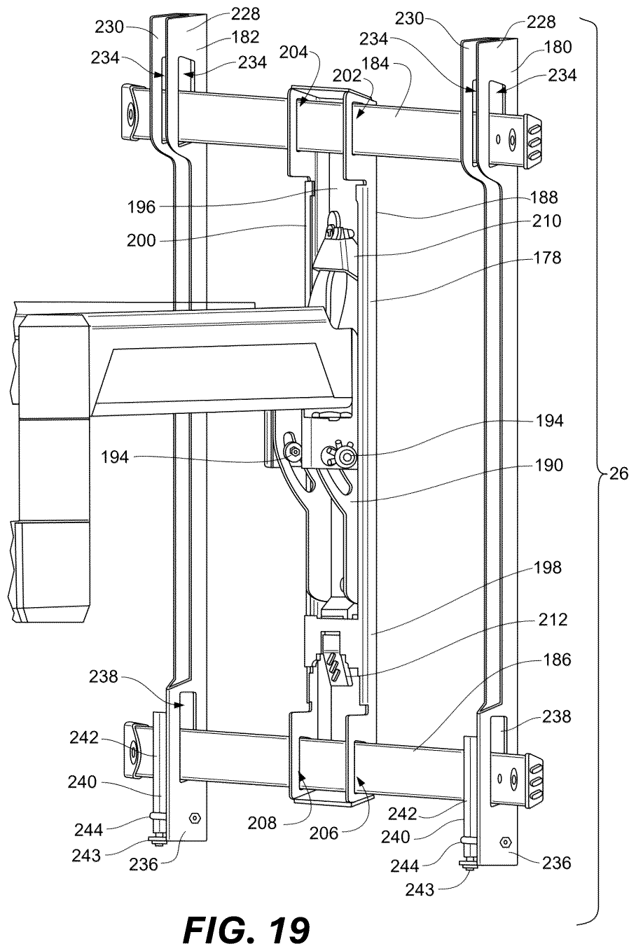

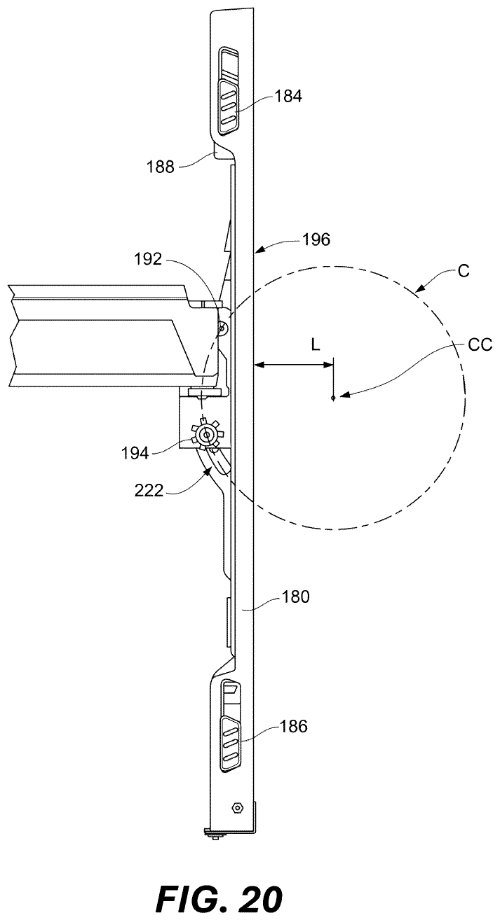

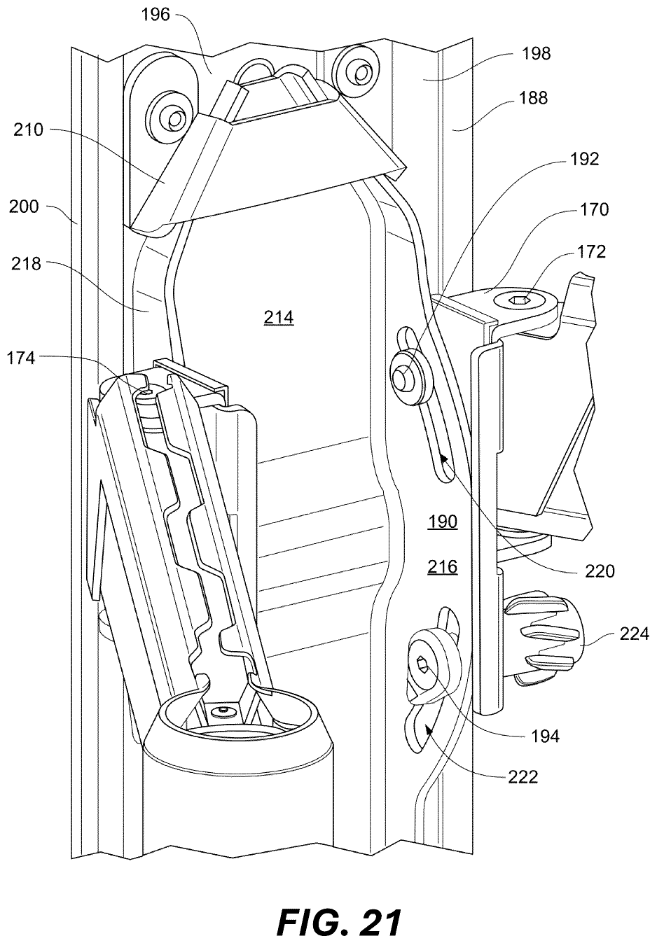

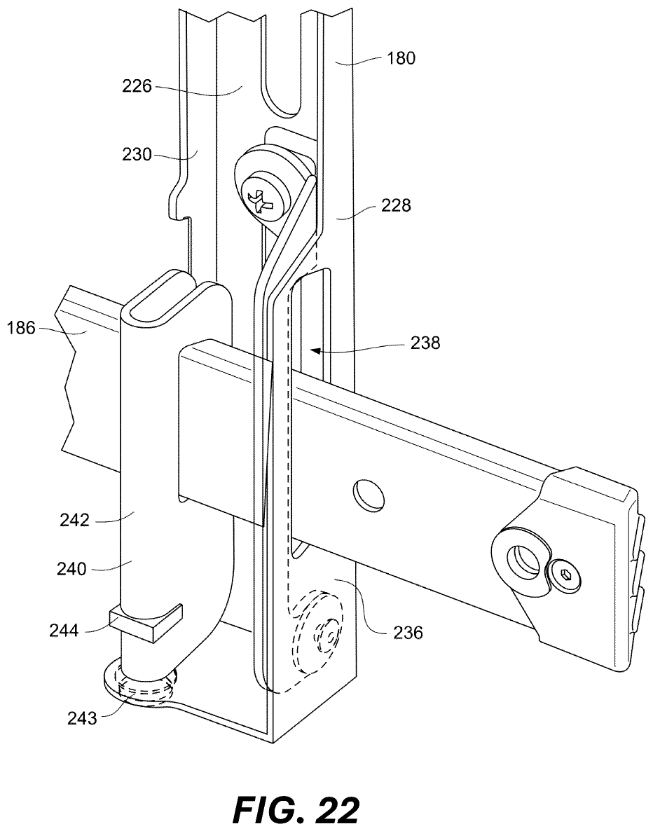

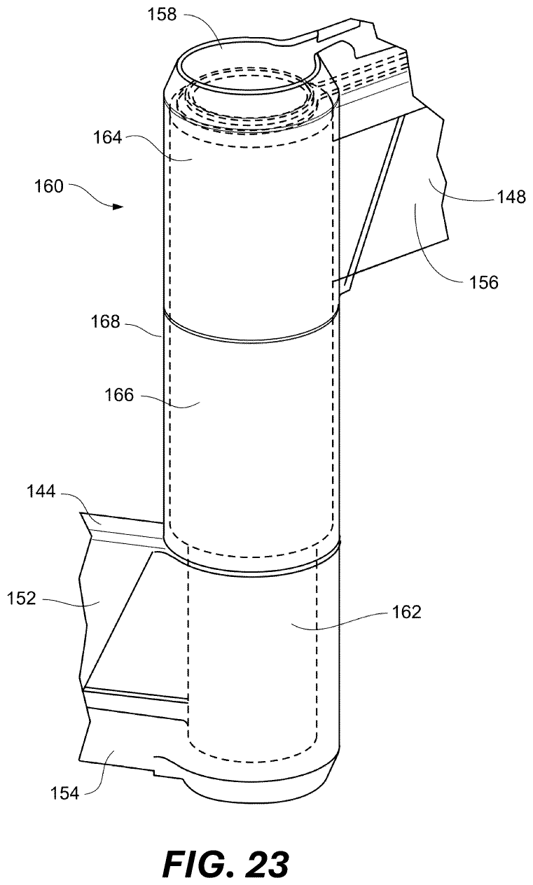

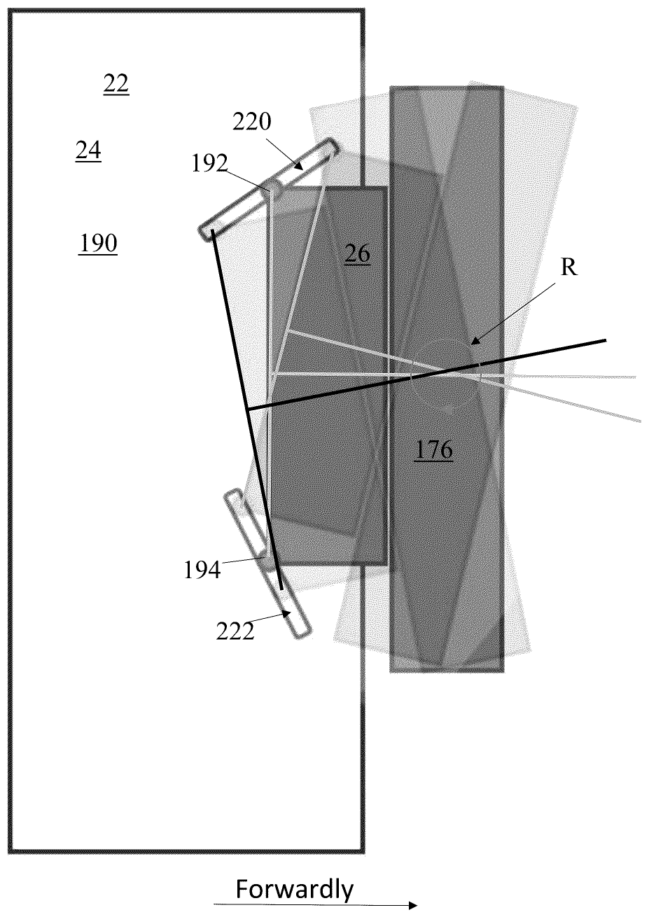

In FIGS. 10-24, various aspects of display mount 20 of FIG. 1 are depicted. Display mount 20 generally includes wall interface assembly 22, arm assembly 24, and display interface assembly 26.

Wall interface assembly 22 generally includes wall attachment brackets 28, 30, cross bars 32, 34, and arm coupling assembly 36. Wall attachment brackets 28, 30, each generally include channel 38, channel cover 40, and clamps 42, 44. Each channel 38 has sidewalls 46, 48, and backplane 50. Side walls 46, 48, have outwardly extending projections 52, 54, at top end 56, and outwardly extending projections 58, 60, at bottom end 62. Projections 52, 54, define apertures 64, 68, and projections 58, 60, define apertures 70, 72. Clamp 42 is pivotally attached between sidewalls 46, 48, with rivet 74, and clamp 44 is pivotally attached between sidewalls 58, 60, with rivet 76. Opposing end 78 of clamp 42 is secured to backplane 50 with fastener 80, and opposing end 82 of clamp 44 is secured to backplane 50 with fastener 84. Backplane 50 defines apertures 86, 88, to receive fasteners (not depicted) to secure channel 38 to wall 90. Channel cover 40 fits between sidewalls 46, 48, to conceal channel recess 92.

Cross bars 32, 34, are slidably received through apertures 64, 68, and 70, 72, respectively. Cross bars 32, 34, have decorative end caps 94.

Arm coupling assembly 36 generally includes backplane 96, upper bushing carrier 98, lower bushing carrier 100, upper bushing 102, lower bushing 104, and arm pivot tubes 106, 108. Backplane 96 is fixed to upper bushing carrier 98, lower bushing carrier 100, and cross bars 32, 34, with rivets 110.

Upper bushing 102 has body portion 112 defining cylindrical recesses 114, 116, and longitudinal slot 118. Upper bushing 102 is fitted into upper bushing carrier 98 as depicted in FIG. 5, with upper ends 120, 122, of arm pivot tubes 106, 108, being rotatably received in cylindrical recesses 114, 116, respectively. Body portion 112 also defines bore 124, which receives threaded shaft 126 of friction adjustment knob 128. Nut 130 is disposed on rear side 132 of body portion 112 and is threaded onto threaded shaft 126. As friction adjustment knob 128 is rotated clockwise, body portion 112 is compressed by nut 130 and flexes, narrowing slot 118 and causing cylindrical recesses 114, 116, to fit more tightly around upper ends 120, 122, of arm pivot tubes 106, 108, thereby increasing the amount of friction resisting rotation of arm pivot tubes 106, 108. When friction adjustment knob 128 is rotated counterclockwise, friction is reduced.

As depicted in FIG. 8 (with lower bushing carrier 100 omitted for clarity), lower bushing 104 has body portion 134 defining cylindrical recesses 136, 138, and longitudinal slot 140. Lower bushing 104 is fitted into lower bushing carrier 100 as depicted in FIG. 6, with lower ends (not depicted) of arm pivot tubes 106, 108, being rotatably received in cylindrical recesses 136, 138. Body portion 134 also defines bore (not depicted), which receives threaded shaft 146 of friction adjustment bolt 142. Nut 143 is disposed on rear side 132 of body portion 134 and is threaded onto threaded shaft 146. As friction adjustment bolt 142 is rotated clockwise, body portion 134 is compressed by nut 143 and flexes, narrowing slot 140 and causing cylindrical recesses 136, 138, to fit more tightly around the lower ends of arm pivot tubes 106, 108, thereby increasing the amount of friction resisting rotation of arm pivot tubes 106, 108. When friction adjustment bolt 142 is rotated counterclockwise, friction is reduced.

It will be appreciated that wall attachment brackets 28, 30, can be attached to wall 90 at locations corresponding to studs in the wall, whether they are located with standard spacing such as 16 or 24 inches, or at a non-standard spacing. Cross bars 32, 34, and arm coupling assembly 36 can then be positioned as desired relative to wall attachment brackets 28, 30, by sliding cross bars 32, 34, in apertures 64, 68, 70, 72, until the desired position is reached. Clamps 42, 44, can then be tightened to secure cross bars 32, 34, in place.

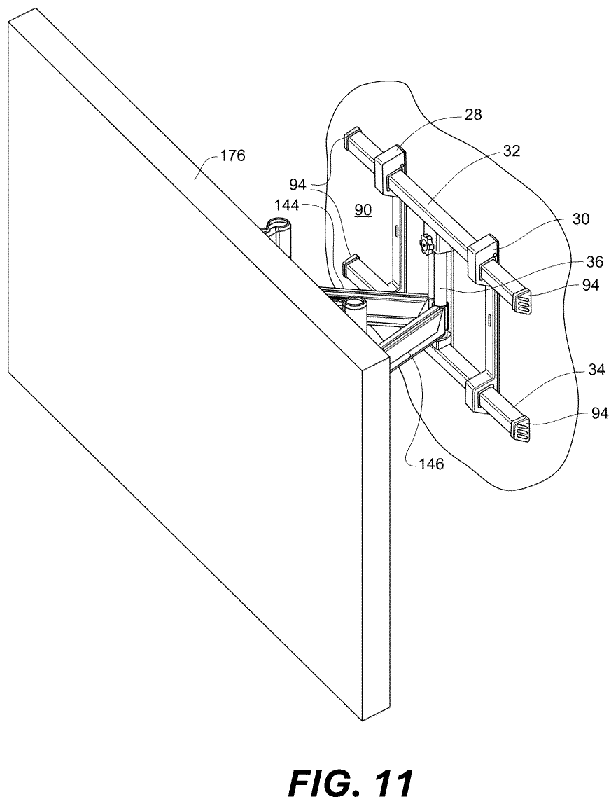

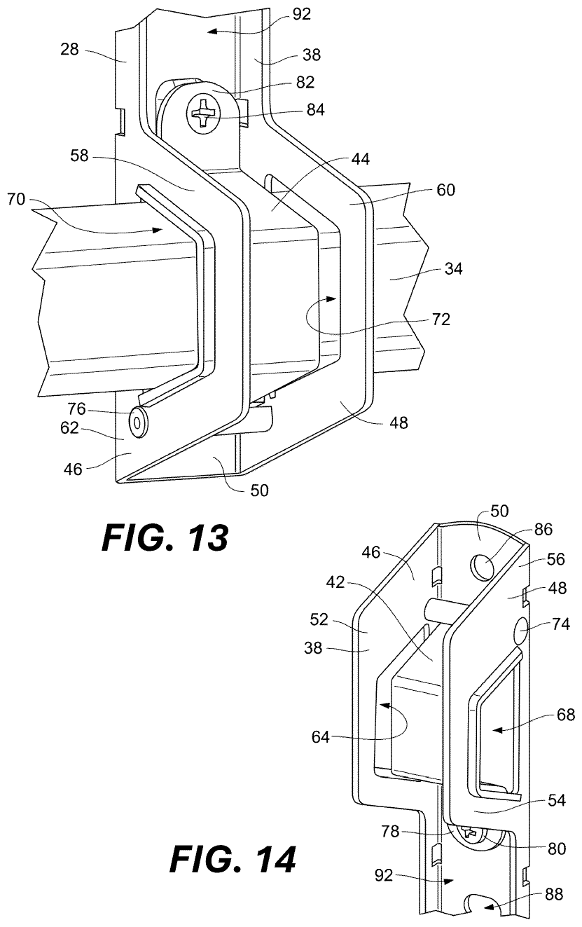

Arm assembly 24 generally includes lower arms 144, 146, and upper arms 148, 150. Each of lower arms 144, 146, has a structural arm portion 152, generally made from metal such as steel, and an arm cover 154, generally made from plastic. Each of upper arms 148, 150, has a structural arm portion 156, generally made from metal such as steel, and an arm cover 158, generally made from plastic. Lower arm 144 and upper arm 148 and lower arm 146 and upper arm 150, respectively are coupled together with a pivoting connection 160 as depicted in exemplary fashion in FIG. 13. Structural arm portion 152 of lower arm 144 is fixed to hollow axle tube 162. Structural arm portion 156 of upper arm 148 has bushing portion 164 which rotatably receives hollow axle tube 162. Spacer 166 is fitted around hollow axle tube 162, and has outer decorative cover 168. As depicted in FIG. 11, upper arms 148, 150, are pivotally connected to display interface carrier bracket 170 with pivot pins 172, 174. It will be appreciated that this arrangement enables lower arm 144 and upper arm 148 and lower arm 146 and upper arm 150 to articulate about hollow axle tubes 162, and pivot about arm pivot tubes 106, 108, and pivot pins 172, 174, such that display interface assembly 26, and an attached television or monitor 176, can be positioned closer to or further away from wall 90, shifted laterally from side-to-side, or angled relative to wall 90.

It will be further appreciated that any wires or cables necessary for supplying power or signal to television or monitor 176 can be managed or concealed by routing them through arm covers 154, 158, and hollow axle tube 162.

Display interface assembly 26 generally includes tilt assembly 178, display mounting brackets 180, 182, and support bars 184, 186. Tilt assembly 178 generally includes tilt interface channel 188, tilt guide bracket 190, upper guide pins 192, and lower guide pins 194. Tilt interface channel 188 has front wall 196 and rearwardly projecting sidewalls 198, 200. Sidewalls 198, 200, define apertures 202, 204, and apertures 206, 208, respectively receiving support bars 184, 186, therethrough.

Tilt guide bracket 190 is fixed to front wall 196 of tilt interface channel 188 with clips 210, 212, and has front wall 214 and rearwardly projecting sidewalls 216, 218. Each of sidewalls 216, 218, defines an upper guide slot 220, and a lower guide slot 222. As depicted in FIG. 10, upper guide slots 220 and lower guide slots 222 can be positioned along the circumference of a circle C having a center CC positioned forwardly by distance L from front wall 196 of tilt interface channel 188. It will be appreciated that the size of circle C and the orientation of slots 220, 222, can be selected so as to give any desired distance L. Preferably, distance L is selected so that center CC is disposed within a television or monitor 176 attached to the mount.

Upper guide pins 192 extend through upper guide slots 220 and slide or roll therein. Similarly, lower guide pins 194 extend through lower guide slots 222 and slide or roll therein. Any of guide pins 192, 194, may be selectively tightened or loosened with an optional friction control knob 224 to add or reduce friction that resists movement of guide pins 192, 194, in slots 220, 222.

Alternatively, as depicted in the schematic diagram of FIG. 24, upper guide slots 220 and lower guide slots 222 can be any geometric shape, including arcuate, straight, or other shape. In the diagram, wall interface 22, arm assembly 24, or tilt guide bracket 190 define upper guide slots 220 and lower guide slots 222. Display interface 26 carries followers in the form of upper guide pin 192, and lower guide pin 194. Television 176 is attached to display interface 26. At any given moment in time, display interface 26 and television 176 can be understood as rotating about an instantaneous axis of rotation or “tilt axis.” If the guide slots are not positioned perfectly symmetrically relative to each other, or are shapes other than arcuate and located along the circumference of a circle, the position of the instantaneous axis of rotation will shift as the display interface 26 and television 176 proceed through the tilting motion. The distance between upper guide pin 192 and lower guide pin 194 is fixed and does not change. At any given tilt position, the instantaneous axis of rotation will lie along a line perpendicular to the midpoint of a line drawn between upper guide pin 192 and lower guide pin 194. As shown, the region R where the perpendicular lines intersect defines the location of the tilt axis of the device. If region R is disposed forwardly (as depicted) relative to the display interface 26, television 176 will tend to maintain its tilt position without excessive friction being introduced into the sliding or rolling connection between upper guide pin 192 and lower guide pin 194 and the respective slots in which they are engaged or an external friction device such as friction control knob 224.

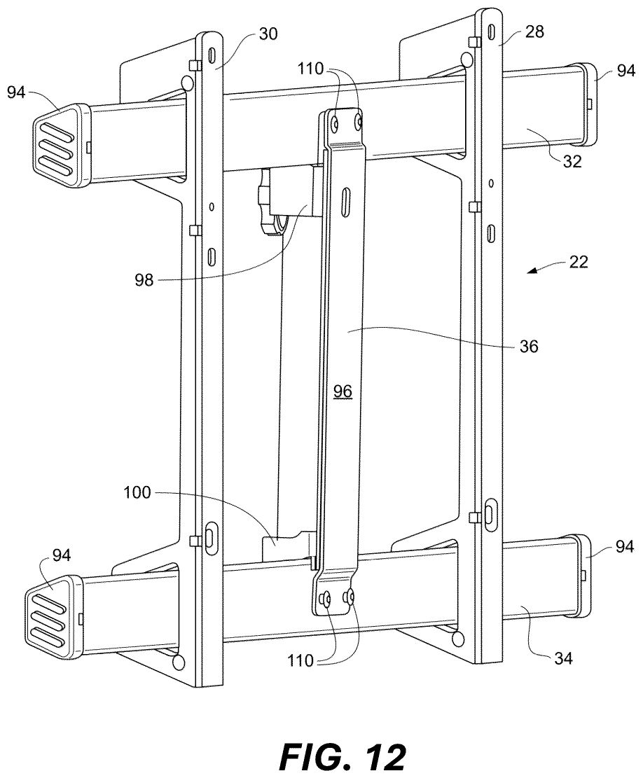

Each of display mounting brackets 180, 182, has a front wall 226 with rearwardly projecting sidewalls 228, 230. Front wall 226 defines apertures 232 for receiving fasteners (not depicted) to attach television or monitor 176. Sidewalls 228, 230, define upper elongated apertures 234. Support bar 184 is received through apertures 234. As depicted in FIGS. 9 and 12, proximate bottom end 236 of each of display mounting brackets 180, 182, sidewall 228 defines lower elongate apertures 238. Support bar 186 is received through apertures 238. Vertical height adjustment assembly 240 generally includes U-shaped bracket 242, threaded bolt 243, and adjustment nut 244. U-shaped bracket 242 is fixed to support bar 186 and is slidable on sidewall 230. Adjustment nut 244 is threaded onto threaded bolt 243. As threaded bolt 243 is rotated, adjustment nut 244 translates, causing U-shaped bracket 242 to move upward or downward. Thereby, each display mounting bracket 180, 182, can be shifted upwardly or downwardly relative to support bars 184, 186, to individually vertically position display mounting brackets 180, 182, and an attached television or monitor 176. It will be appreciated that individual adjustment of vertical height adjustment assemblies 240 can also permit vertical skewing (different left and right-side height) of the television or monitor 176 if desired.

In use, wall attachment brackets 28, 30, can be affixed to studs in a wall 90 to match the spacing of the studs, whether standard spacing such as 16 or 24 inches, or a non-standard spacing. Cross bars 32, 34, can be shifted relative to wall attachment brackets 28, 30, to achieve the desired lateral positioning on the wall 90. Clamps 42, 44, can then be tightened to inhibit further shifting of cross bars 32, 34. Display mounting brackets 180, 182, can be attached to the rear side of television or monitor 176, and coupled to support bars 184, 186. Display mounting brackets 180, 182, can be positioned laterally along support bars 184, 186, equidistant from tilt assembly 178 to match the spacing of attachment points on television or monitor 176. Vertical height adjustment assemblies 240 can be adjusted to shift the position of television or monitor 176 vertically or to skew the display if desired. The television or monitor 176 can be tilted about a virtual horizontal axis passing through center CC of circle C. This tilting motion is more fully described in U.S. Pat. No. 6,905,101, owned by the owners of the present invention and hereby fully incorporated herein by reference.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A mount for attaching a television to a structure, comprising:
a wall interface adapted to attach to the structure;
a display interface adapted to attach to the television, the display interface operably coupled to the wall interface such that the display interface is selectively shiftable in pitch and yaw relative to the wall interface; and
a pair of handle assemblies operably coupled to the display interface, each handle assembly having an elongate shaft with a pair of opposing ends, one of the opposing ends coupled to the display interface and the other one of the opposing ends having a grip portion, each handle assembly being selectively shiftable amongst a first extended position wherein the shaft extends in a generally horizontal direction and the grip portion is disposed laterally outward from the display interface, a second intermediate position wherein the shaft portion extends in a generally vertical direction and the grip portion is disposed above or below the display interface, and a third stowed position wherein the shaft extends in a generally horizontal direction and the grip portion is disposed above or below the display interface.

2. The mount of claim 1, wherein the display interface includes a pair of vertically spaced-apart support bars, each support bar presenting a pair of opposing ends, one of the handle assemblies being pivotally coupled to a first one of the support bars proximate one of the opposing ends of the support bar, the other one of the handle assemblies being pivotally coupled to the first one of the support bars proximate the other of the opposing ends of the support bar.

3. The mount of claim 2, wherein each handle assembly further comprises a guide plate defining a guide slot, and wherein the support bar carries a corresponding guide pin engaged and slidable in the guide slot.

4. The mount of claim 1, wherein the mount further comprises an arm assembly operably coupling the wall interface and the display interface.

5. The mount of claim 1, wherein the mount includes a tilt guide bracket defining a pair of vertically spaced-apart guide slots and operably coupled to the display interface, and wherein the mount further includes a pair of guide pins operably coupled to the wall interface, each one of the pair of guide pins engaged in a separate one of the guide slots, thereby enabling the display interface to tilt about a generally horizontal tilt axis disposed forwardly from the display interface.

6. The mount of claim 5, wherein the guide slots are arcuate and disposed along the circumference of a circle, the circle having a center disposed forwardly from the display interface.

7. The mount of claim 1, wherein the mount includes a tilt guide bracket defining a pair of vertically spaced-apart guide slots and operably coupled to the display interface, and wherein the mount further includes a pair of guide pins operably coupled to the wall interface, each one of the pair of guide pins engaged in a separate one of the guide slots, thereby enabling the display interface to tilt about a generally horizontal instantaneous tilt axis disposed forwardly from the display interface.

8. The mount of claim 7, wherein the guide slots are straight.

9. The mount of claim 7, wherein the guide slots are disposed asymmetrically relative to each other.

10. A video display system, comprising:
a television or display monitor; and
a mount for movably attaching the television or display monitor to a wall, the mount comprising;
a wall interface adapted to attach to the wall;
a display interface attached to the television or display monitor, the display interface operably coupled to the wall interface such that the display interface is selectively shiftable in pitch and yaw relative to the wall interface; and
a pair of handle assemblies operably coupled to the display interface, each handle assembly having an elongate shaft with a pair of opposing ends, one of the opposing ends coupled to the display interface and the other one of the opposing ends having a grip portion, each handle assembly being selectively shiftable amongst a first extended position wherein the shaft extends in a generally horizontal direction and the grip portion is disposed laterally outward from the display interface, a second intermediate position wherein the shaft portion extends in a generally vertical direction and the grip portion is disposed above or below the display interface, and a third stowed position wherein the shaft extends in a generally horizontal direction and the grip portion is disposed above or below the display interface.

11. The system of claim 10, wherein the display interface includes a pair of vertically spaced-apart support bars, each support bar presenting a pair of opposing ends, one of the handle assemblies being pivotally coupled to a first one of the support bars proximate one of the opposing ends of the support bar, the other one of the handle assemblies being pivotally coupled to the first one of the support bars proximate the other of the opposing ends of the support bar.

12. The system of claim 11, wherein each handle assembly further comprises a guide plate defining a guide slot, and wherein the support bar carries a corresponding guide pin engaged and slidable in the guide slot.

13. The system of claim 10, wherein the mount further comprises an arm assembly operably coupling the wall interface and the display interface.

14. The system of claim 10, wherein the mount includes a tilt guide bracket defining a pair of vertically spaced-apart guide slots and operably coupled to the display interface, and wherein the mount further includes a pair of guide pins operably coupled to the wall interface, each one of the pair of guide pins engaged in a separate one of the guide slots, thereby enabling the display interface to tilt about a generally horizontal tilt axis disposed forwardly from the display interface.

15. The system of claim 14, wherein the guide slots are arcuate and disposed along the circumference of a circle, the circle having a center disposed forwardly from the display interface.

16. The system of claim 10, wherein the mount includes a tilt guide bracket defining a pair of vertically spaced-apart guide slots and operably coupled to the display interface, and wherein the mount further includes a pair of guide pins operably coupled to the wall interface, each one of the pair of guide pins engaged in a separate one of the guide slots, thereby enabling the display interface to tilt about a generally horizontal instantaneous tilt axis disposed forwardly from the display interface.

17. The system of claim 16, wherein the guide slots are straight.

18. The system of claim 16, wherein the guide slots are disposed asymmetrically relative to each other.

19. A method of positioning a television or display monitor relative to a structure, the method comprising:
providing a mount, the mount comprising:
a wall interface adapted to attach to the structure;
a display interface adapted to attach to the television or display monitor, the display interface operably couplable to the wall interface such that the display interface is selectively shiftable in pitch and yaw relative to the wall interface;
a pair of handle assemblies operably coupled to the display interface, each handle assembly having an elongate shaft with a pair of opposing ends, one of the opposing ends coupled to the display interface and the other one of the opposing ends having a grip portion, each handle assembly being selectively shiftable amongst a first extended position wherein the shaft extends in a generally horizontal direction and the grip portion is disposed laterally outward from the display interface, a second intermediate position wherein the shaft portion extends in a generally vertical direction and the grip portion is disposed above or below the display interface, and a third stowed position wherein the shaft extends in a generally horizontal direction and the grip portion is disposed above or below the display interface;
attaching the wall interface to the structure;
attaching the display interface to the television or display monitor;
shifting each of the handle assemblies to the first extended position;
coupling the display interface to the wall interface;
shifting each of the handle assemblies to the second intermediate position; and
shifting the television or display monitor to a desired pitch position or a desired yaw position using the handle assemblies.

20. The method of claim 19, further comprising shifting the handle assemblies to the stowed position.
